(19) United States
(12) Patent Application Publication
(10) Pub. No.: US 2017/0024442 A1
(43) Pub. Date: Jan. 26, 2017

(54) ELECTRONIC DEVICE AND METHOD OF ACQUIRING USER INFORMATION IN ELECTRONIC DEVICE

(71) Applicant: Samsung Electronics Co., Ltd., Gyeonggi-do (KR)

(72) Inventors: Joo-Yeon PARK, Seoul (KR); Hae-Mi YOON, Seoul (KR); Ji-Hun LEE, Seoul (KR); Hyun-Yeul LEE, Seoul (KR)

(21) Appl. No.: 15/215,721

(22) Filed: Jul. 21, 2016

(30) Foreign Application Priority Data
Jul. 21, 2015 (KR) 10-2015-0103135

(51) Int. Cl. G06F 17/30; G06F 9/48; H04L 29/06

(52) U.S. Cl. CPC G06F 17/30525; H04L 67/42; G06F 17/30979; G06F 9/4843; G06F 17/30722

(57) ABSTRACT

Disclosed is an electronic device and a method of acquiring user information in an electronic device. The electronic device includes an input/output interface, a memory storing first user information, and a processor, configured to: when a first task of a first application executed by the electronic device is terminated, output via the input/output interface a query requesting second user information related to at least one of the first task and the first user information, and receive the requested second user information via a user input received by the input/output interface responsive to the query, and store the received second user information in the memory.

### CLAIM OF PRIORITY

This application claims priority under 35 U.S.C. §119(a) to Korean Application Serial No. 10-2015-0103135, which was filed in the Korean Intellectual Property Office on Jul. 21, 2015, the entire content of which is hereby incorporated by reference.

### TECHNICAL FIELD

The present disclosure relates to an acquiring user information in an electronic device, and more particularly, to interactive electronic agents for acquiring information.

### BACKGROUND

Recently, various electronic devices have been developed to use various functions related to applications. For example, the electronic device (for example, a smart phone) may execute an application and output a response corresponding to a user input (for example, a voice).

The electronic device has a display unit to more effectively use various functions. For example, in a case of a recent smart phone, a touch-sensitive display unit (for example, a touch screen) is provided on a front surface thereof.

In addition, various types of applications (for example, referred to as “Apps”) may be installed and executed in electronic devices. Various input means (for example, a touch screen, buttons, a mouse, a keyboard, a sensor or the like) may be used to execute and control the applications in the electronic device.

### SUMMARY

User information may be stored in an electronic device through various applications or services. When a connection between the electronic device and the application or the service is not supported, the electronic device may have difficulty in identifying user information input for the application or the service.

According to various embodiments of the present disclosure, an electronic device and a method of acquiring user information by an electronic device may output a query based on a task or pre-stored user information when the task of an application or a service is terminated.

In accordance with an aspect of the present disclosure, an electronic device is provided. The electronic device includes an input/output interface, a memory that stores first user information, and a processor operatively coupled to the memory and the input/output interface. The processor is configured to: when a first task of a first application executed by the electronic device is terminated, output via the input/output interface a query requesting second user information related to at least one of the first task and the first user information, and receive the requested second user information via a user input received by the input/output interface responsive to the query, and store the received second user information in the memory. In accordance with another aspect of the present disclosure, a method of acquiring user information in an electronic device is provided. The method includes storing in a memory first user information, detecting by a processor when a first task of a first application executed by the electronic device is terminated, and when the first task is terminate, outputting via an input/output interface a query requesting second user information associated with at least one of the first task and the stored first user information, and receive the request second user information via a user input received by the input/output interface response to the query, and store the received second user information in in the memory.

According to various embodiments of the present disclosure, an electronic device and a method of acquiring user information in an electronic device may output, when a task of an application or a service is terminated, a query based on the task or pre-stored user information, thereby acquiring user information according to various execution environments.

### BRIEF DESCRIPTION OF THE DRAWINGS

The above and other aspects and features of the present disclosure will be more apparent from the following detailed description taken in conjunction with the accompanying drawings, in which:

FIG. 1 is a block diagram illustrating an example of a network environment, according to various embodiments of the present disclosure;

FIG. 2 is a block diagram illustrating an example of a configuration of an electronic device according to various embodiments of the present disclosure;

FIG. 3 is a flowchart illustrating an example of an operation for acquiring user information according to various embodiments of the present disclosure;

FIG. 4 illustrates an example of a system for acquiring user information according to various embodiments of the present disclosure;

FIG. 5A is a flowchart illustrating an example of an operation in which the electronic device selects a query based on stored user information according to various embodiments of the present disclosure;

FIG. 5B is a flowchart illustrating an example of an operation for receiving a response to an output query and storing user information according to various embodiments of the present disclosure;

FIG. 6 illustrates an example of an operation for inquiring about whether to perform an operation of acquiring user information according to various embodiments of the present disclosure;

FIG. 7 illustrates an example of an operation for inquiring about whether to perform an operation of acquiring user information according to various embodiments of the present disclosure;

FIG. 8 illustrates an example of an operation for outputting a query for acquiring user information according to various embodiments of the present disclosure;

FIG. 9 illustrates an example of an operation for outputting a query for acquiring user information according to various embodiments of the present disclosure;

FIG. 10 illustrates an example of an operation for outputting a query for acquiring user information according to various embodiments of the present disclosure;

FIG. 11 illustrates an example of an operation in which the electronic device outputs a response according to various embodiments of the present disclosure;

FIG. 12 is a flowchart illustrating an example of an operation in which the electronic device outputs a response according to various embodiments of the present disclosure;

FIG. 13 illustrates an example of an operation in which the electronic device outputs a response according to various embodiments of the present disclosure;

FIG. 14 illustrates an example of an operation in which the electronic device applies an effect to an output agent according to various embodiments of the present disclosure;

FIG. 15 is a block diagram illustrating an example of a configuration of an electronic device according to various embodiments of the present disclosure; and

FIG. 16 is a block diagram illustrating an example of a configuration of a program module according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) for performing the corresponding operations or a generic-purpose processor (e.g., central processing unit (CPU) or application processor (AP)) that can perform the corresponding operations by executing one or more software programs stored in a memory device.

The terms used in the present disclosure are used to describe specific embodiments, and are not intended to limit the present disclosure. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to various embodiments of the present disclosure, the electronic device may be a home appliance. The smart home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to various embodiments of the present disclosure, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

According to various embodiments of the present disclosure, user information corresponds to information related to a particular user and may include information which the corresponding user knows or experiences.

According to various embodiments of the present disclosure, applications (for example, application programs) may include one or more applications which can perform functions such as home, dialer, messaging (SMS, MMS, or IM (Instant Message)), browser, camera, alarm, contact, voice dial, email, calendar, media player, album, clock, health care (for example, measuring exercise quantity, motion, blood pressure, weight, body fat, or blood sugar), measuring geographic information (GPS), schedule planner, writing a document (for example, note or memo), or providing environmental information (for example, providing air pressure, humidity, or temperature information).

According to various embodiments of the present disclosure, the application may be executed in the unit of tasks. For example, the task may include at least one activity for performing an independent function through at least one layout, and may be displayed as a configuration unit of one screen or executed in the background.

According to various embodiments of the present disclosure, data of the task may include various pieces of data utilized for executing a task of an application in an electronic device such as information on a task executed at a particular time point or data input for the task, and the data may include various types of data such as text data, image data, media data, user input data, file data, voice data, or sensor data.

An output operation according to various embodiments of the present disclosure may include an operation for allowing corresponding data to be identified from the outside of the electronic device. For example, the electronic device may process data to be image data or text data to be output through a display of the electronic device or process the data to be voice data to be output through a speaker. The data may be processed and output in various forms of data based on various configurations of the electronic device.

An agent according to various embodiments of the present disclosure may be an element of software or a program stored in or electrically connected to the electronic device. For example, the agent may output a query for acquiring user information or a response through the electronic device by transferring data input based on a voice recognition function to the electronic device or identifying data stored in the electronic device.

Hereinafter, an electronic device according to various embodiments of the present document and a method of acquiring user information in an electronic device will be described with reference to the accompanying drawings. As used herein, the term “user” may indicate a person who uses an electronic device or a device (for example, an artificial intelligence electronic device) that uses an electronic device.

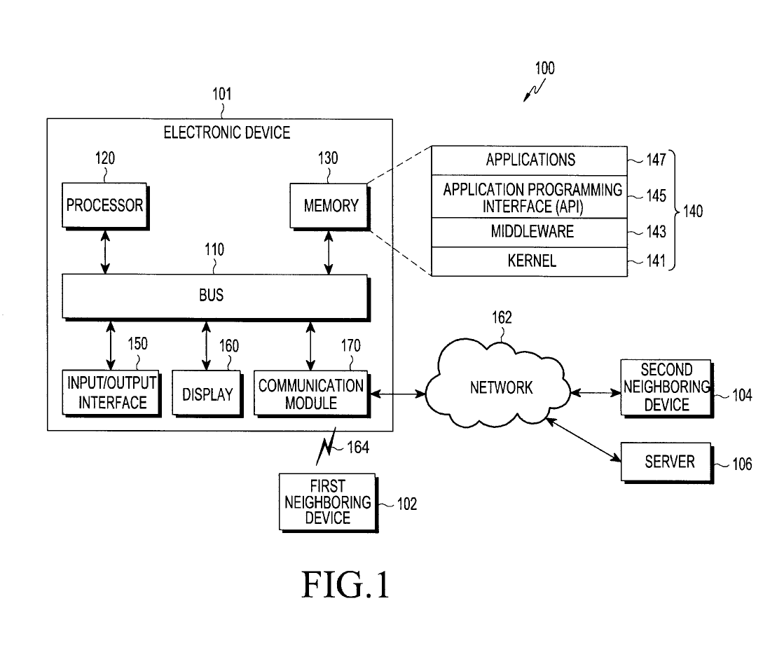

FIG. 1 is a block diagram illustrating an example of a network environment, according to various embodiments of the present disclosure.

Referring to FIG. 1, a network environment 100 may include an electronic device 101, and at least one electronic device (for example, a first neighboring external electronic device 102 or a second neighboring external electronic device 104) or a server 106, and the elements may be connected through a network 162 or connected to the electronic device 101 through a communication module 170 of the electronic device 101.

The electronic device 101 may include a bus 110, a processor 120, a memory 130, an input/output interface 150, a display 160, and a communication module 170. In some embodiments, the electronic device 101 may omit at least one of the above elements or may further include other elements.

The bus 110 may include, for example, a circuit which interconnects the elements 110 to 170 and delivers communication (for example, a control message and/or data) between the elements 110 to 170.

The processor 120 may include one or more of a Central Processing Unit (CPU), an Application Processor (AP), and a Communication Processor (CP). For example, the processor 120 may carry out operations or data processing relating to control and/or communication of at least one other element of the electronic device 101.

The memory 130 may include a volatile memory and/or a non-volatile memory. The memory 130 may store, for example, instructions or data related to at least one other element of the electronic device 101. According to an embodiment, the memory 130 may store software and/or a program 140. The program 140 may include a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage, for example, system resources (for example, the bus 110, the processor 120, and the memory 130) which are used to execute an operation or a function implemented in the other programs (for example, the middleware 143, the API 145, and the application programs 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data.

The middleware 143 may process one or more task requests, which are received from the application programs 147, according to priorities thereof. For example, the middleware 143 may assign priorities for using the system resources (for example, the bus 110, the processor 120, the memory 130, or the like) of the electronic device 101, to at least one of the application programs 147. For example, the middleware 143 may perform scheduling or load balancing on the one or more task requests by processing the one or more task requests according to the priorities assigned thereto.

The API 145 is an interface through which the applications 147 control functions provided from the kernel 141 or the middleware 143, and may include, for example, at least one interface or function (for example, instruction) for file control, window control, image processing, or text control.

The input/output interface 150 may function as, for example, an interface that may transfer a command or data input from a user or another external device to the other element(s) of the electronic device 101. Furthermore, the input/output interface 150 may output the instructions or data received from the other element(s) of the electronic device 101 to the user or another external device.

The display 160 may include, for example, a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (for example, text, images, videos, icons, or symbols) for the user. The display 160 may include a touch screen and receive, for example, a touch, gesture, proximity, or hovering input using an electronic pen or the user's body part.

The communication module 170 may set communication between, for example, the electronic device 101 and an external device (for example, a first neighbor external electronic device 102, a second external electronic device 104, or a server 106). For example, the communication module 170 may be connected to a network 162 through wireless or wired communication to communicate with the external device (for example, the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short-range communication 164. The short-range communication 164 may include at least one of, for example, Wi-Fi, Bluetooth, Near Field Communication (NFC), and Global Navigation Satellite System (GNSS). The GNSS may include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, the “GPS” may be interchangeably used with the “GNSS”. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include at least one of a communication network such as a computer network (for example, a LAN or a WAN), the Internet, and a telephone network.

Each of the first and second neighboring external electronic devices 102 and 104 may be a device which is the same as or different from the electronic device 101. According to an embodiment, the server 106 may include a group of one or more servers. According to various embodiments, all or some of the operations performed by the electronic device 101 may be performed by another electronic device or a plurality of electronic devices (for example, the neighboring device 102 or 104 or the server 106). According to an embodiment, when the electronic device 101 has to perform some functions or services automatically or in response to a request, the electronic device 101 may make a request for performing at least some functions relating thereto to another device (for example, the neighboring external electronic device 102 or 104 or the server 106) instead of performing the functions or services by itself or in addition. Another electronic device (for example, the electronic device 102 or 104, or the server 106) may execute the requested functions or the additional functions, and may deliver a result of the execution to the electronic device 101. The electronic device 101 may provide the received result as it is or additionally process the received result and provide the requested functions or services. To achieve this, for example, for example, technology such as cloud computing, distributed computing, and client-server computing may be used.

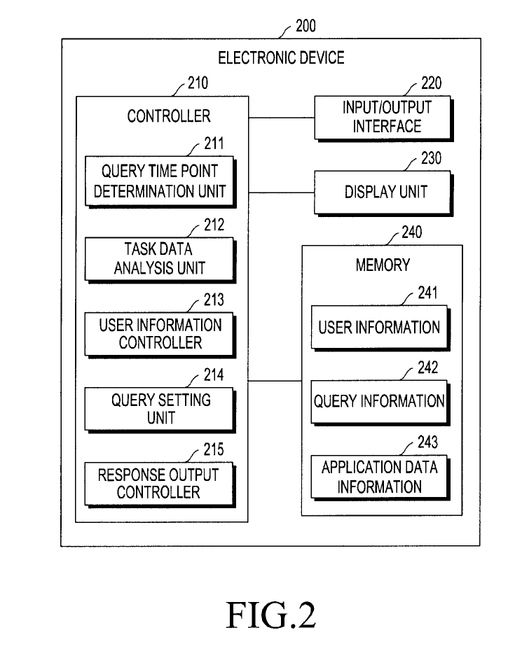

FIG. 2 is a block diagram illustrating an example of a configuration of an electronic device according to various embodiments of the present disclosure.

Referring to FIG. 2, an electronic device 200 may include at least one of a controller 210, an input/output interface 220, a display unit 230, and a memory 240.

The controller 210 may include at least one of a query time point determination unit 211, a task data analysis unit 212, a user information controller 213, a query setting unit 214, and a response output controller 215, and further include various elements for performing a function of acquiring user information.

The query time point determination unit 211 may determine a time point to output a query for acquiring user information. For example, the query time point determination unit 211 may determine a time point when an executed task is temporarily stopped for a predetermined time or is terminated as a time point to output the query.

According to various embodiments of the present disclosure, a query type includes a query for performing an operation of acquiring user information or a query for acquiring user information. For example, the query for performing an operation of acquiring the user information may include queries of identifying whether to perform the operation of acquiring user information such as “Can I ask you a question?” or “By the way, I have a question”.

According to various embodiments of the present disclosure, when a task of the application executed in the electronic device 200 is terminated, the query time point determination unit 211 may make a control to output a query for acquiring user information.

According to various embodiments of the present disclosure, when a voice signal (verbal cue) (for example, “okay”, “thank you” or the like) related to the termination of a particular task is input, a button (for example, save or done) related to completion of the task is selected, or a particular hardware/software key (for example, a home key or a back key) is selected, the electronic device 200 may determine that the task is terminated. For example, when at least one of a task with an agent, an information input, a search operation, a phone call, content use, and application download is completed, the electronic device 200 may determine that the corresponding task is terminated. In the other various cases where a user's input operation is not performed for a predetermined time, the electronic device 200 may determine that the executed task is terminated.

The task data analysis unit 212 may analyze a task of an executed application or service and extract at least one keyword included in data of the task. For example, the task data analysis unit 212 may classify the corresponding keyword by identifying classification of user information corresponding to the extracted keyword.

According to various embodiments of the present disclosure, the classification of the user information may include basic information, location and connection information or behavior and tendency information.

The basic information may include an email, address, nickname, favorites, or schedule information of the user, and may include information acquired from an account connected to the corresponding user.

The location and connection information may include information related to a place of the user (for example, home or office) or information on an electronic device which is determined as being connected or in proximity.

The behavior and tendency information may include information related to a behavior, tendency, or interest of the user, and may be acquired based on log data of a particular application, location information, or application or content use information. For example, data acquired as the behavior and tendency information may be classified into various user information which can be classified based on a particular reference such as shopping information, travel information, culture information, media information, schedule information, Internet information, application (app purchase or app installation) information, social networking information, function setting information, communication information, memo information, and the like. The classified information may be included in the behavior and tendency information in the form of a data field.

The user information controller 213 may manage user information newly acquired or stored through creation, update, deletion, or edit according to each data field or each classification of the user information.

The query setting unit 214 may select a query to be output in connection with user information. For example, the query setting unit 214 may set a query according to a type of query to be output or user information to be acquired.

According to various embodiments of the present disclosure, the query setting unit 214 may select the type of query to be output according to stored user information, classification of user information, a termination time point of a task, an input response of the query, or an execution state of a task.

According to various embodiments of the present disclosure, a query type may include a query for performing an operation of acquiring user information or a query for acquiring user information.

The response output controller 215 may identify a response to the made user input or an expected response to the output query, and output data corresponding to the identified response. For example, the response output controller 215 may make a control so that the user may identify a response to a particular query by outputting, as the data corresponding to the response, data in various forms of data such as a list including at least one selection item, an indicator displaying a function through a dynamic button, image data, character data, or voice data.

The input/output interface 220 may convert data input into the electronic device 200 into a signal, which can be processed by the electronic device 200, output a query for acquiring user information, or identify a response input from the outside.

According to various embodiments of the present disclosure, the input/output interface 220 may process data received from the outside of the electronic device 200 to be identified by the electronic device 200. For example, the input/output interface 220 may process data to be image data or text data to be output through the display unit 230 or process the data to be voice data to be input/output through a speaker (not shown) or a microphone (not shown). The input/output data may be processed as data, which can be input/output through a corresponding element, based on various elements connected to the electronic device 200.

The display unit 230 may output a query for acquiring user information in the form of image data or text data.

According to various embodiments of the present disclosure, the display unit 230 may display at least one item, which can be selected as a response to a particular query, simultaneously with the output of the corresponding query.

The memory 240 may store various pieces of information for acquiring the user information 241. For example, the memory 240 may store particular user information 241 classified into basic information, location and connection information, or behavior and tendency information. The memory 240 may also store query information 242 relating to informational inquiries, or application data information 243 for various associated applications.

According to various embodiments of the present disclosure, the classification of the user information 241 may include at least one data field, and the electronic device may determine at least one data field having no value or non-classified user information as non-stored user information.

For example, the data field of the basic information may include a name, address, phone number, or birthday field. The connection information may include a location, connection time, or network information field. The shopping information may include a field of a purchased product or information on a product within a shopping cart. The travel information may include a field of visited country/region information, period of travel, plane mileage, vacation plan, or desired country to be visited. The culture information may include a field of information on a movie, play, musical, book, or exhibition (genre, cast, author, viewing site, or viewing date). The media information may include a field of information on music (for example, lyricist/composer or singer information), video, or photo (for example, photography date, tagged user information, or photography place) stored in the electronic device. The schedule information may include a field of schedule classification (business (meeting, business trip, or workshop), or personal (appointment or visiting hospital)), or schedule period/place. The Internet information may include a field of a favorite site, search word, or viewed video. The app store information may include a field of an application downloaded or purchased from an app store. The relation information may include a field of user information within SNS friend/account friend/contact or contact information frequently used for a call or message. The setting information may include a field of information related to settings of various functions within the electronic device. The communication information may include a field of transmission and reception of an email/message/call (counterpart or main content). The memo may include a field of memo information which the user usually stores. The map-related information may include a field of a found place or traffic information.

According to various embodiments of the present disclosure, the memory 240 may store application data information 243 including data of an application at a time point when the task is terminated. For example, data of a phone call (for example, dialer, call, or phone) application may include a file having a recent log or a contact list. Data of a messaging application may include a keyboard file for inputting information on an activity for transmitting/receiving a message to/from another user, execution information (message thread) for transmitting/receiving a message, or text data.

Data of an alarm application may include information related to alarm settings such as an alarm scheduled time, a number of alarms, or alarm sound information, a timer setting time, or previously configured timer setting time.

Data of the schedule management (planner) application is data for managing a user's schedule, and may include weather information of the generated schedule, participant information, location information, or information on a business to be performed, and also include information on a time or a method of a reminder.

Data of the health care application may include information for calling an activity to track data related to health information (for example, exercise quantity, motion, blood pressure, weight, body fat, sleep, or blood sugar) detected through at least one sensor (for example, UV sensor, motion sensor, or pedometer) or the health information.

Data of the media player application may include a media file having a reproduced video, music, and image, and may include a composer/lyricist of the corresponding media file, singer, album information, information on a play list including at least one media file due to be reproduced, a purchase list of media files, or information on whether the media file is stored in a server.

Data of the browser application may include URL information of at least one webpage output through a browser application, bookmark, search information, or favorite information.

Data of the application market may include information of a purchased or downloaded application.

For example, an electronic device according to various embodiments may include an input/output interface, a memory that stores first user information, and a processor that makes a control to, when a first task of a first application executed in the electronic device is terminated, output a query for acquiring second user information related to at least one of the first task and the first user information through the input/output interface and store a user input made through the input/output interface in the memory as the second user information in response to the query.

For example, the processor may make a control to determine whether the user input made through the input/output interface corresponds to the second user information and to store the user input in the memory in response to the query.

For example, the processor may make a control to classify the first user information or the second user information into basic information, location and connection information, or behavior and tendency information and to store the classified information in the memory.

For example, when the query is output, the processor may output at least one item which can be selected as a response of the query in connection with the second user information.

For example, when one of the at least one item is selected, the processor may store information corresponding to the selected response in the memory such that the information is contained in the second user information.

For example, when a third task for outputting a response to a command is terminated based on a voice recognition function executed in the electronic device, the processor may determine whether third user information related to the command is stored and make a control to output a query for acquiring the third user information related to the third task through the input/output interface.

For example, when a preset button (search button, back key, or home key) is selected or an operation related to completion or storage is performed in the electronic device, the processor may determine that a fourth task for inputting information is terminated and make a control to output a query for acquiring fourth user information related to at least one keyword included in the fourth task through the input/output interface.

For example, when a fifth task related to a download of an application is terminated in the electronic device, the processor may make a control to output a query for acquiring fifth user information related to at least one application included in the fifth task through the input/output interface.

For example, the processor may make a control to output a query for acquiring additional information of the second user information through the input/output interface based on the made user input and the second user information.

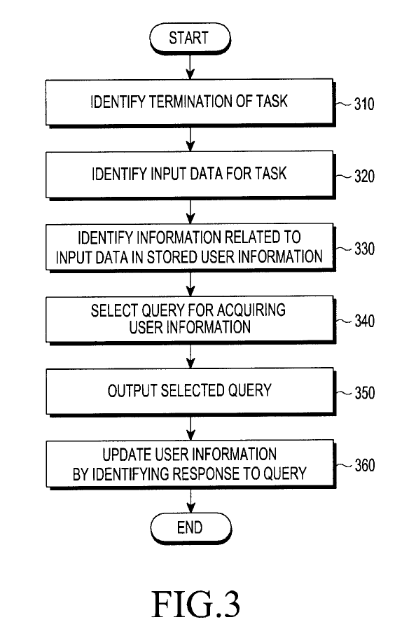

FIG. 3 is a flowchart illustrating an example of an operation for acquiring user information according to various embodiments of the present disclosure.

Referring to FIG. 3, in operation 310, the electronic device may determine a time point in which an operation to acquire user information is to be performed. For example, the electronic device may acquire user information when identifying that a particular task has been terminated (e.g., a task termination time point).

In operation 320, the electronic device may identify input data for a task. For example, the electronic device may classify the input data for the task based on (or by identifying) a classification of particular user information.

In operation 330, the electronic device may identify information related to the input data in stored user information. For example, the electronic device may determine whether the stored information includes data corresponding to the identified classification of the user information, and identify a data field which is not stored in connection with the input data among the stored user information.

In operation 340, the electronic device may select a query for acquiring user information. For example, the output query may include a query for inquiring the user about whether to perform the operation for acquiring the user information or a query for acquiring the user information.

According to various embodiments of the present disclosure, the query for inquiring the user about whether to perform the operation for acquiring the user information may include a meaning about whether a question may be asked for acquiring user information, such as “By the way, can I ask you something?” or “I have a question.”.

According to various embodiments of the present disclosure, the query for acquiring the user information may include a query that makes a request for information on a data field which is not stored in connection with input data. For example, when data on a viewing date field or a theater field is not identified for a particular movie in the culture information, the electronic device may select a query which can receive, as a response, a value of a particular data field such as “When did you watch ** movie?” or “Where did you watch it?”.

In operation 350, the electronic device may output the selected query. For example, the electronic device may output the selected query in various types according to a user's characteristic (for example, gender or age). For example, the output query may be output through a voice or dynamic display, and a language and a voice tone/pitch/gender may be set for the voice.

In operation 360, the electronic device may update user information by identifying a response to the query. For example, the electronic device may identify classification of particular user information among the stored user information and a data field by analyzing the received response and insert the received response into the corresponding data field.

At least one of the operations illustrated in FIG. 3 may be omitted, or at least one other operation may be added between the operations. In addition, the operations may be sequentially processed as illustrated in FIG. 3, and the execution sequence of at least one operation may be switched with that of another operation.

For example, a method of acquiring user information in an electronic device according to various embodiments of the present disclosure may include, when a first task of a first application executed in the electronic device is terminated, an operation of outputting a query for acquiring second user information related to at least one of the first task and stored first user information, and an operation of storing a made user input as the second user information in response to the query.

For example, the method of acquiring user information in an electronic device according to various embodiments of the present disclosure may further include an operation of, when the made user input corresponds to the second user information, storing the made user input as the second user information.

For example, the method of acquiring user information in an electronic device according to various embodiments of the present disclosure may further include an operation of classifying the first user information or the second user information into basic information, location and connection information, or behavior and tendency information and storing the classified information.

For example, the method of acquiring user information in an electronic device according to various embodiments of the present disclosure may further include an operation of, when the query is output, outputting at least one item which can be selected as a response to the query in connection with the second user information.

For example, the method of acquiring user information in an electronic device according to various embodiments of the present disclosure may further include an operation of, when one of the at least one item is selected, storing information corresponding to the selected response such that the information is contained in the second user information.

For example, the method of acquiring user information in an electronic device according to various embodiments of the present disclosure may further include an operation of, when a third task for outputting a response to a command is terminated based on a voice recognition function executed in the electronic device, determining whether third user information related to the command is stored, and an operation of outputting a query for acquiring the third user information related to the third task.

For example, the method of acquiring user information in an electronic device according to various embodiments of the present disclosure may further include an operation of, when a preset button is selected or an operation related to completion or storage is performed in the electronic device, determining that a fourth task for inputting information is terminated, and an operation of outputting a query for acquiring fourth user information related to at least one keyword included in the fourth task.

For example, the method of acquiring user information in an electronic device according to various embodiments of the present disclosure may further include an operation of, when a fifth task related to a download of an application is terminated in the electronic device, outputting a query for acquiring fifth user information related to at least one application included in the fifth task.

For example, the method of acquiring user information in an electronic device according to various embodiments of the present disclosure may further include an operation of outputting a query for acquiring additional information of the second user information based on the made user input and the second user information.

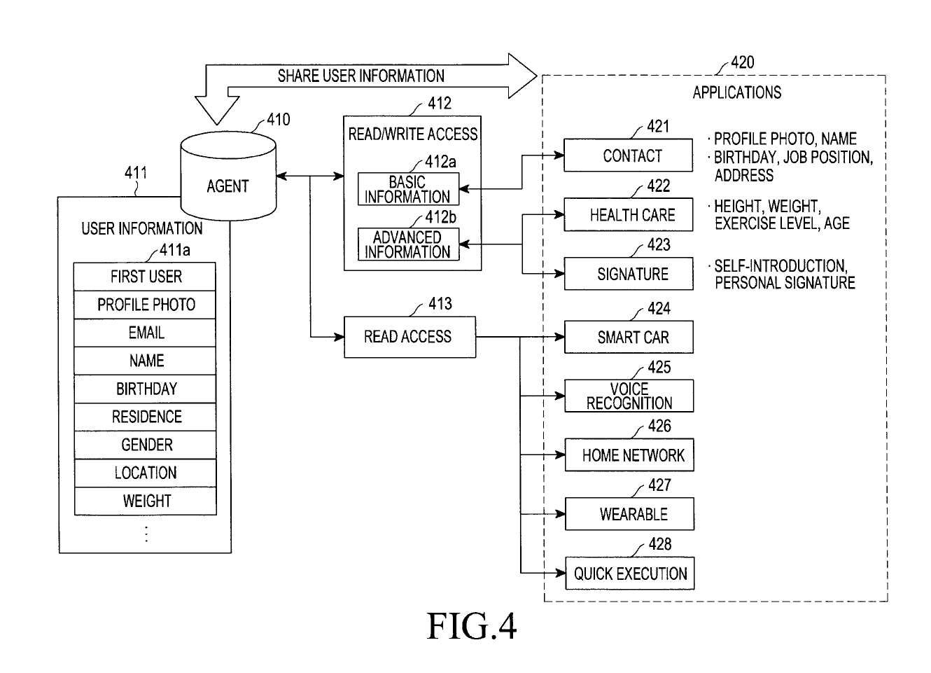

FIG. 4 illustrates an example of a system for acquiring user information according to various embodiments of the present disclosure.

Referring to FIG. 4, a system may acquire user information through an agent 410 or applications 420.

The agent 410 may store the user information 411, information on whether a particular application has a read/write access 412, and/or whether a particular application has read access 413. The different types of information may be stored in a memory (for example, the memory 130) of the electronic device, or in a functionally connected server or device. For example, the agent 410 may identify data of a particular application based on the read/write access 412 or the read access 413.

The user information 411 may include information 411a indicating a number of information types which may be stored for each particular user (for example, a first user). For example, the information may include information related to at least one of a profile photo, email, name, birthday, residence, gender, location, or weight, etc.

In the read/write access 412, the data of the particular application may be classified as basic information 412a or advanced information 412b. For example, basic information 412a may include data for a contact application 421 may be, and advanced information 512b may include data of a health care application 422 or a signature application 423.

Read access 413 may indicate data which can be read by the agent 410, including data of applications such as a smart car application 424 (for example, connect car), a voice recognition application 425, a home network application 426, a wearable application 427, and a quick execution application 428.

According to various embodiments of the present disclosure, the agent 410 may be a system, an electronic device, a server, or software in various forms which can perform an operation of outputting a query for acquiring user information based on user information stored in the memory (for example, the memory 130) of the electronic device or data transmitted from the application 147 and updating the stored user information according to a response to the output query in order to acquire user information.

The applications 420 may include any implemented application, such as the contact application 421, the health care application 422, the signature application 423 (for example, pen up), the smart car application 424 (for example, connect car), the voice recognition application 425, the home network application 426, the wearable application 427, and the quick execution application, and may be various types of applications which can process user information.

According to various embodiments of the present disclosure, the applications 420 may process various pieces of user information based on data included in each task. For example, the user information may include a profile, image, name, birthday, job position, or address information output through the contact application 421. A height, weight, exercise level, or age information may be processed through the health care application 422. Personal introduction or personal signature information may be processed through the signature application 423.

According to various embodiments, information processed through the applications 420 may receive read/write access 412 by which read or write is possible by the agent 410 or the read access 415 by which read is possible according to importance. For example, the application receiving the read/write access 412 may include the contact application 421, the health care application 422, and the signature application 423, and the application receiving the read access 415 may include the smart car application 424, the voice recognition application 425, the home network application 426, the wearable application 427, and the quick execution application 428.

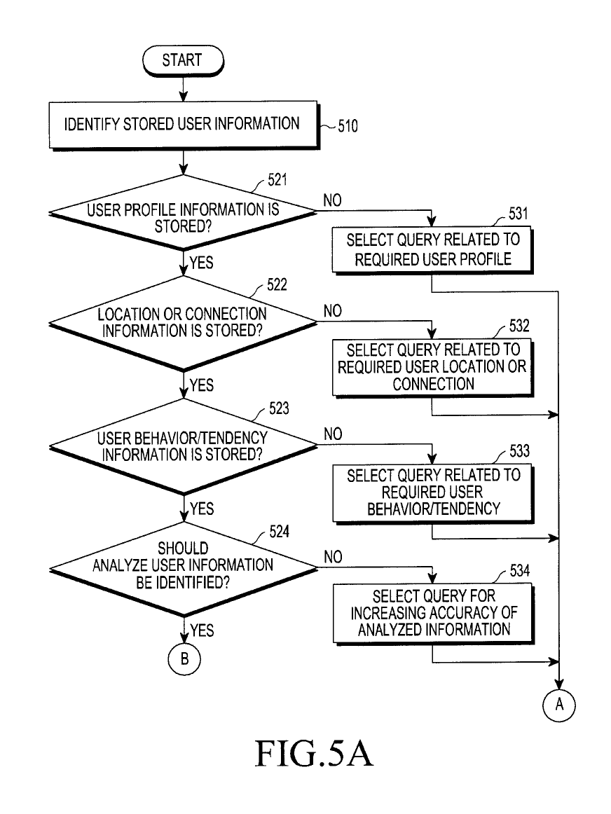

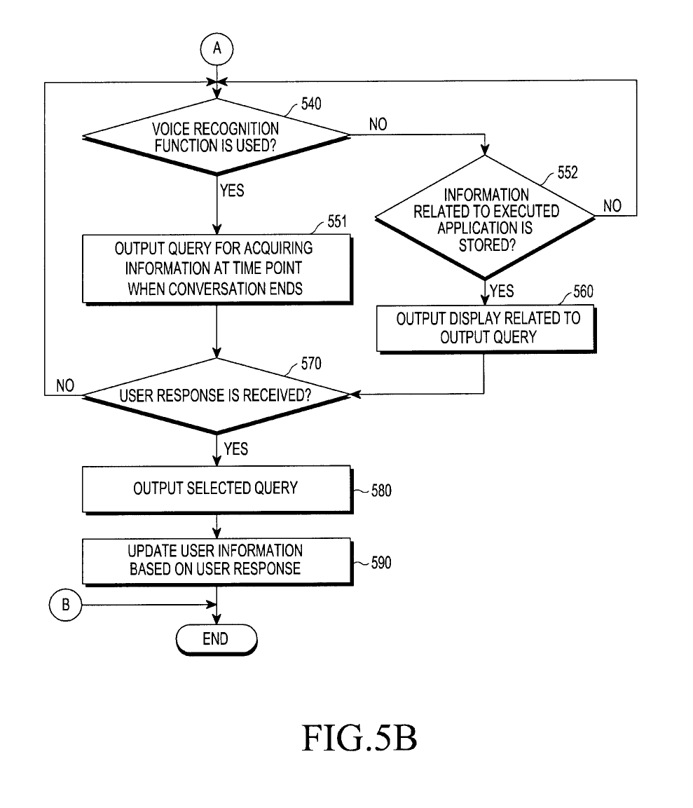

FIG. 5A is a flowchart illustrating an example of an operation in which the electronic device selects a query based on stored user information according to various embodiments of the present disclosure.

Referring to FIG. 5A, in operation 510, the electronic device may identify stored user information. For example, the electronic device may identify data of a terminated task, and determine whether user information related to the identified data for the terminated task is stored in memory or on a server.

According to various embodiments of the present disclosure, the stored user information may be classified into profile information, location or connection information or behavior/tendency information.

In operation 521, the electronic device may determine whether user profile information is stored in the identified stored user information.

When the user profile information is identified as stored in operation 521, the electronic device may identify whether information related to a location or a connection is included in the stored user information.

When the information related to the location or the connection is positive identified in the stored user information in operation 522, the electronic device may identify whether information related to a user's behavior or tendency is contained in the stored user information in operation 523.

When the information related to the user's behavior or tendency is included in the stored user information in operation 523, the electronic device may determine whether to identify “analyzed” user information from among the stored user information in operation 524. For example, the analyzed user information may include data that was analyzed and then stored as task data of a previously executed application and stored as part of the user information.

When the user profile information is indicated as not stored in operation 521, the electronic device may select a query for acquiring the user profile information in operation 531.

When the information related to the user's location or connection is indicated as not stored in operation 522, the electronic device may select a query for acquiring the information related to the user's location or connection in operation 532.

When the information related to the user's behavior or tendency is indicated as not stored in operation 523, the electronic device may select a query for acquiring the information related to the user's behavior or tendency in operation 533.

When it is determined that identifying the stored user information is desirable in operation 524, the electronic device may select a query requesting identification of at least one of the analyzed information in operation 534.

FIG. 5B is a flowchart illustrating an example of an operation for receiving a response to an output query and storing user information according to various embodiments of the present disclosure.

Referring to FIG. 5B, according to the performance of operation 531, 532, 533, or 534, the electronic device may determine whether to utilize a voice recognition function (for example, S voice) to output one or more of the selected queries (e.g., from operations 531-534) in operation 540. For example, the electronic device may perform the operation 540 using at least one application which is set to input or output sound information. The electronic device may determine that the voice recognition function is utilized according to whether the sound information through at least one application is inputted.

When determining that the voice recognition function is to be used in operation 540, the electronic device may output a query for acquiring information at a time point when a “conversation” is terminated in operation 551. For example, the electronic device may determine that a conversation may be deemed terminated when a voice signal related to the termination is detected, or a selection of a button or a particular hardware/software key related to task completion is detected.

According to various embodiments of the present disclosure, the conversation may include communication data corresponding to messages received from a messaging service, a data of a phone call application or any type of data to be communicated for communication between users.

When the voice recognition function is not used based on the result of the performance of operation 540, the electronic device may determine whether information related to an executed application is stored in memory, as indicated in operation 552.

When the information related to the executed application is determined to be stored in operation 552, the electronic device may output a display related to the query output in operation 551. For example, a selection item may be displayed, allowing for selection of at least one piece of information related to the stored application.

According to the performance of operation 551 and/or 552, the electronic device may determine whether a user response is received in operation 570. For example, the electronic device may detect an input from a user responsive to the query output in operation 551 or operation 560.

According to various embodiments of the present disclosure, the user may input data in the form of a voice or text for the output query or display or select at least one selection item among the output displays, and input a response corresponding to the output query.

In operation 580, the electronic device may select a query for acquiring user information according to each type by identifying the response corresponding to the output query and output the selected query. For example, the electronic device may determine whether information corresponding to a particular type is contained in the stored user information and select a relevant query according to an order of basic information, location or connection information, and behavior/tendency information of the user or according to other various set orders.

In operation 590, the electronic device may update the stored user information by identifying the input user made responsive to the output query. For example, the electronic device may classify the user information corresponding to the response, identify a data file of the user information in the corresponding type, insert the response into the corresponding data field, and store the response.

At least one of the operations illustrated in FIG. 5A or 5B may be omitted, or at least one other operation may be added between the operations. In addition, the operations of FIG. 5A or 5B may be sequentially processed as illustrated, or the execution sequence of at least one operation may be switched with that of another operation.

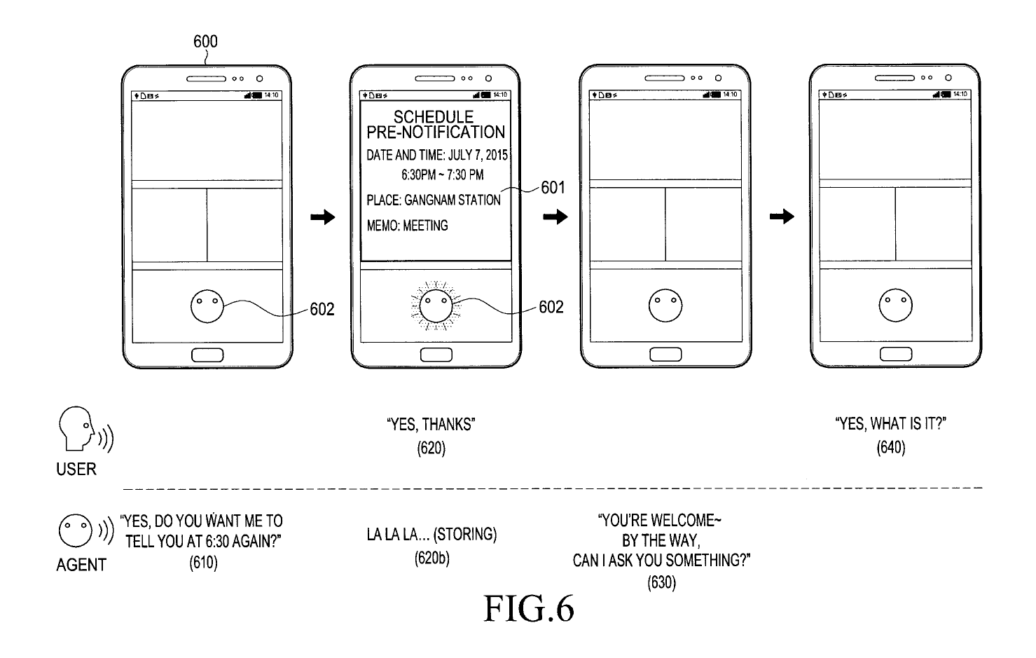

FIG. 6 illustrates an example of an operation for inquiring about whether to perform an operation of acquiring user information according to various embodiments of the present disclosure.

According to various embodiments of the present disclosure, an electronic device 600 may implement or be communicatively coupled to an agent supporting a voice recognition function. The agent may identify user information stored in a memory of the electronic device 600, or access a server or another electronic device to identify stored user information for a particular user.

According to various embodiments of the present disclosure, as illustrated in FIG. 6, a schedule management application may be executed, in which the user may execute a registration operation which a movie viewing schedule is generated and registered through the schedule management application, and the electronic device may detect termination of schedule generation task in the schedule management application according to completion of the registration operation.

Referring to FIG. 6, the agent 602 may generate a query inquiring whether to perform an operation related to a generated schedule when a scheduled event has been generated in the schedule management application, as seen in operation 610. The query may include the question: “Yes, do you want me to tell you (about the completely generated schedule) at 6:30 again?” An image 602 of the agent may be output along with the query.

In operation 620, the user may input a response to the output query. For example, the user may input, “Yes, thanks” as a positive response to the output query. The positive response may include other phrases such as, “okay,” “cool,” and “yes, thanks.”

When the positive response to the output query is detected, the agent may store the response in the electronic device 600, as seen in in operation 620b. For example, the agent may store the response such that an operation for informing of the generated schedule at 6:30 is performed. Further, the agent 602 may generate an output acknowledging the user input, or indicative of a storing operation, such as “La La La,” as illustrated.

When the positive response to the output query is identified, the agent may also determine that this initial “conversation” with the user has been completed and/or terminated. The agent 602 may then output a query inquiring whether to acquire information related to the schedule management application through the electronic device 600, as seen in operation 630. For example, the agent 602 may output a query including content such as “You're welcome˜ by the way, can I ask you something?” Further, the content of the query may be configured include or utilize various contents or data forms, according to user settings or other configurations.

In operation 640, the user may input a response to the query which inquires whether to perform the operation for acquiring the information. For example, the user may input a positive response that accepts the performance of the operation for acquiring the information. The positive response may include content such as “Yes, what is it?”

According to various embodiments of the present disclosure, when the positive response that accepts the performance of the operation for acquiring the information is input, the agent may output the query for acquiring the user information based on the stored user information.

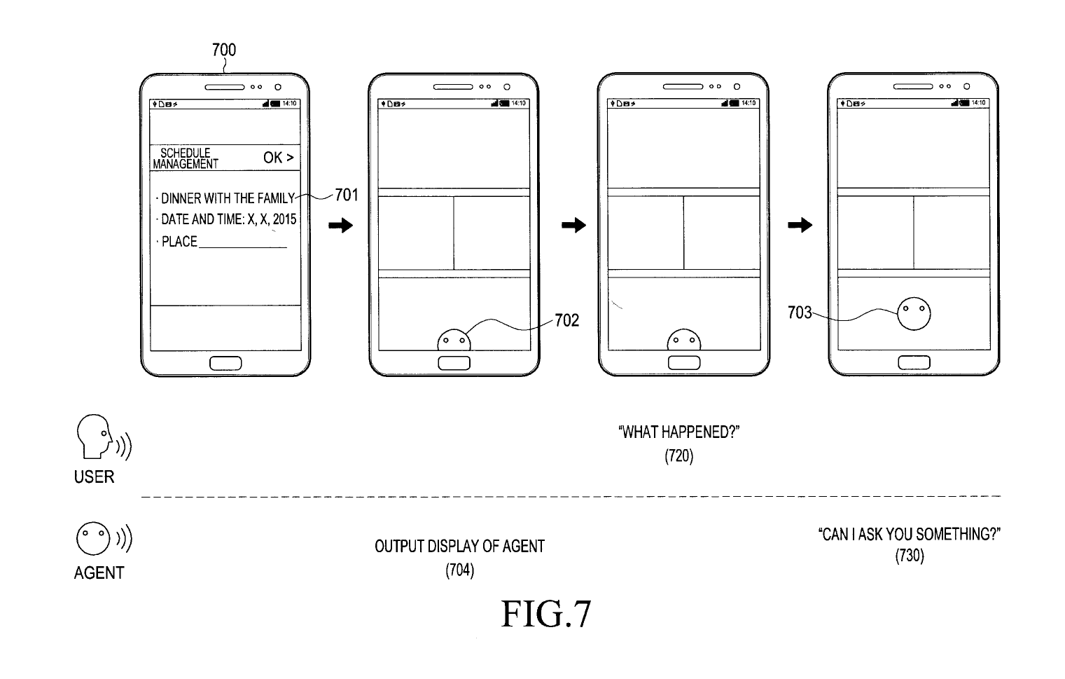

FIG. 7 illustrates an example of an operation for inquiring about whether to perform an operation of acquiring user information according to various embodiments of the present disclosure.

According to various embodiments of the present disclosure, a schedule 701 related to an appointment for dinner may be generated in the electronic device through a schedule management application, and the agent may inquire the user about whether to perform an operation for acquiring information in connection with the generated schedule.

In operation 704, the agent may be displayed as an image 702 representing the agent. For example, while the agent 702 may be output in the form of image, it is noted that the agent may also be represented by text or voice.

According to various embodiments of the present disclosure, when information is to be acquired in connection with the generated schedule is identified, the electronic device 700 may output the image 702 of the agent.

In operation 720, the user may input a response to the agent image. For example, the user may input a response corresponding to a question about why the suddenly displayed image 702 of the agent appeared, and the response may include the content of “What happened?”

In operation 730, the agent may output a query inquiring about whether to perform an operation for acquiring information based on the user's response to the displayed image of the agent 702. For example, the user's response may include ignorance, positive, negative, or deletion.

According to various embodiments of the present disclosure, when the user's response is positive, the agent may inquire about whether to output a query to acquire information, and the query may include the content of “Can I ask you something?” For example, the output query may have various forms such as a voice, text, or image having the content of inquiring about whether to output the query.

According to various embodiments of the present disclosure, when the positive response that accepts the performance of the operation for acquiring the information is input, the agent may output the query for acquiring the user information based on the stored user information.

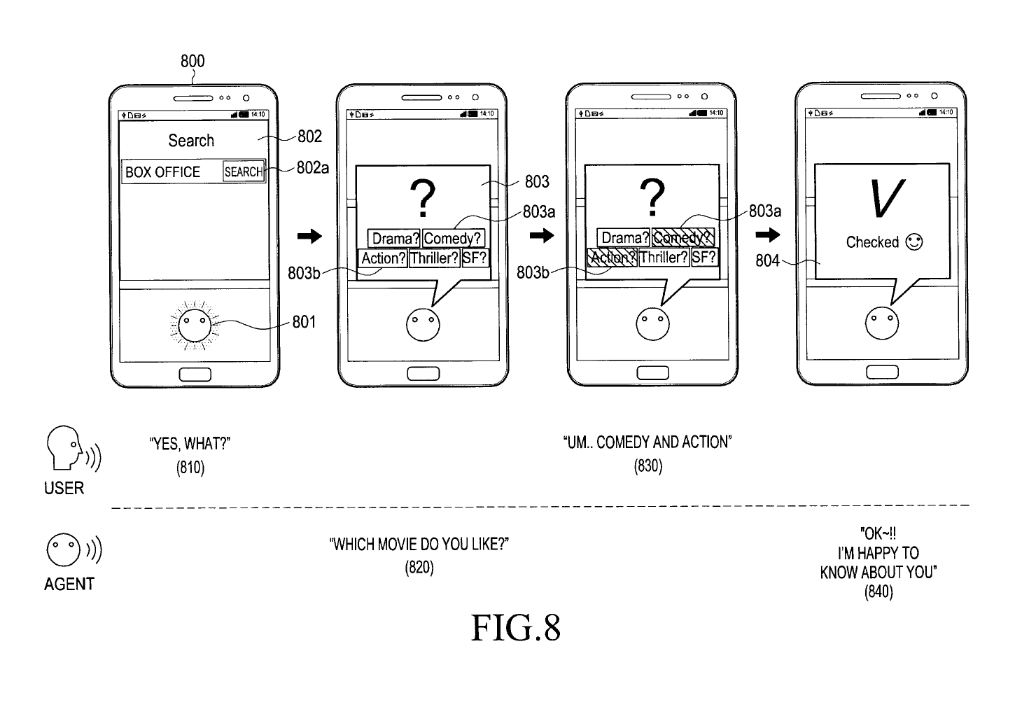

FIG. 8 illustrates an example of an operation for outputting a query for acquiring user information according to various embodiments of the present disclosure.

According to various embodiments of the present disclosure, the user may search for information related to a movie through an electronic device 800. For example, the user may input a search string “box office,” as seen in screen 802, which may be displayed within an application providing a web browser or a search function. The search may be executed when detecting selection of a search button 802a.

According to various embodiments of the present disclosure, when the electronic device 800 detects selection of the search button 802a and thus performs a search operation resulting in output of a search result related to the searched-for keyword or string, the electronic device 800 may determine that the search task has terminated or completed for the corresponding search application. For example, the electronic device 800 may determine whether to perform an operation for acquiring user information by outputting an image 801 of the agent, and receiving a user input in at least partial response the output image 801 of the agent.

Referring to FIG. 8, in operation 810, the user may input the content of “Yes, what is it?” as a response to the image 801 of the agent. For example, the agent may determine that the user's response to the image 801 of the agent is a positive response and output the query for acquiring the user information.

In operation 820, the agent may output the content of “Which movie do you like?” as the query for acquiring the user information related to data of the search task and output a selection item 803 for the output query through the electronic device 800. For example, the selection item 803 may include at least one item such as “Drama?,” “Comedy?” 803a, “Action?” 803b, “Thriller?”, or “SF” which may indicate Science Fiction, all of which are selectable by the user.

According to various embodiments of the present disclosure, the agent may identify the “box office” input as the search keyword among data included in the task and identify classification of user information corresponding to the keyword. For example, the “box office” is a keyword associated with a movie, and the agent may identify user's behavior and tendency information among the user information and identify whether “movie information” is contained in the behavior and tendency information.

According to various embodiments of the present disclosure, when information on a movie genre is not identified in the “movie information”, the agent may output a query for inquiring about which movie is preferred as a query for generating the “movie information” in the behavior and tendency information of the user information.

According to various embodiments of the present disclosure, the agent may store information on the movie genre or make a request for the movie genre to the server and receive it from the server.

In operation 830, the user may select the comedy? 803a or the action? 803b in the selection item 803 manually, or alternatively, may input voice data representing the selection, such as: “um . . . comedy and action” which instruct the agent 801 to select “Comedy?” 803a or “Action?” 803b.

In operation 840, the agent may store information on the selected item and output a message informing of the termination of the operation for acquiring the user information. For example, the message may include the content of “Is that right? I'm happy to know about you” or “OK˜!! I'm happy to know about you.”

According to various embodiments of the present disclosure, the agent may insert data on the selected item into a data field corresponding to the movie genre and store the data in the “movie information” of the user.

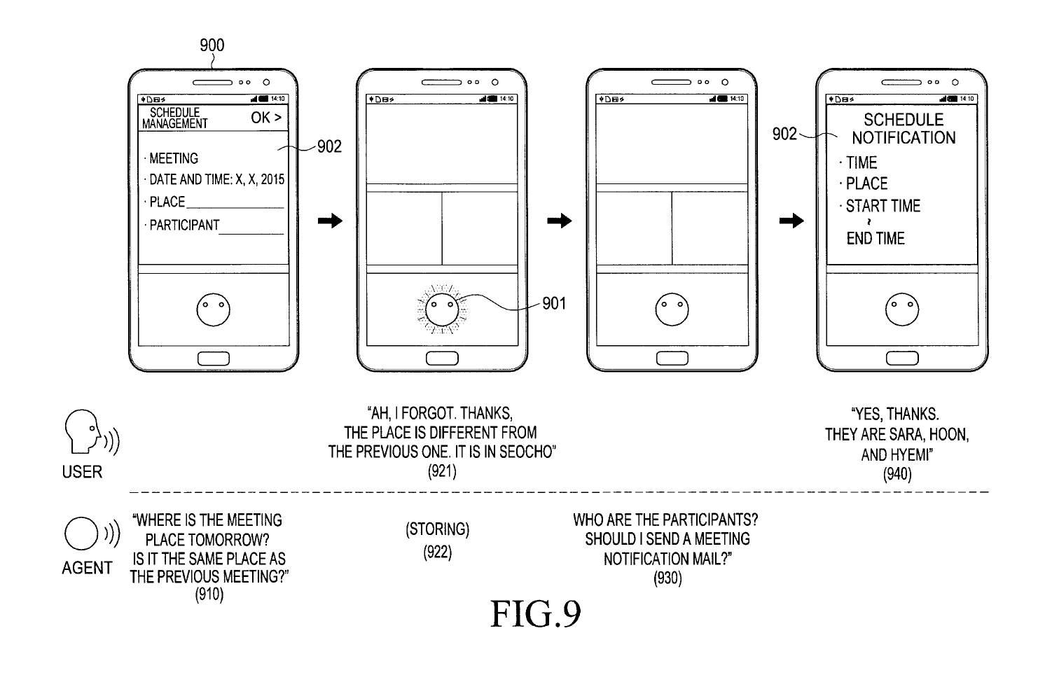

FIG. 9 illustrates an example of an operation for outputting a query for acquiring user information according to various embodiments of the present disclosure.

According to various embodiments of the present disclosure, the user may generate a schedule through an electronic device 900. For example, the user may input information related to the schedule through a screen 902 of a schedule management application and select an ok button.

According to various embodiments of the present disclosure, when the electronic device 900 identifies the selection of the ok button and performs an operation for storing the generated schedule, the electronic device 900 may determine that a task for schedule generation is termination in the corresponding application. For example, when a query for inquiring about whether to perform the operation for acquiring user information is output and a response to the output query is received, the agent may perform the operation for acquiring the user information.

Referring to FIG. 9, in operation 910, the agent may output the query for acquiring user information in connection with the generated schedule. For example, the agent may output the content of “Where is the meeting place tomorrow? Is it at the same place as the previous meeting?” as the query for acquiring information (for example, place or participants) of the generated schedule which has not been identified.

In operation 921, the user may input a response to the output query. For example, the user's response may include “Ah, I forgot. Thanks, the place is different from the previous one. It is in Seocho”.

According to various embodiments of the present disclosure, the agent may insert information indicating “Seocho” into a data field for a location in the generated schedule, and store the information based on the received user response.

According to various embodiments of the present disclosure, the agent may output a query for acquiring another piece of user information in connection with the generated schedule.

In operation 930, the agent may output a query inquiring regarding identification of participants, or whether to execute transmitting notification mail to the corresponding participants. For example, the content of the query may include “Who are the participants? Should I send a meeting notification mail?”

In operation 940, the user may input a response to the query regarding possible participants. For example, the response may include the content of “Yes, thanks. They are Sara, Hoon, and Hyemi”.

According to various embodiments of the present disclosure, the agent may determine that “Sara”, “Hoon”, or “Hyemi” are a direct response to the inquiry regarding participants, and determine, as a positive response, “Yes, thanks” input as responsive to the query as to whether to transmit the notification mail. For example, the agent may insert information indicating each participant into a data field corresponding to the participant and store the information in the generated schedule.

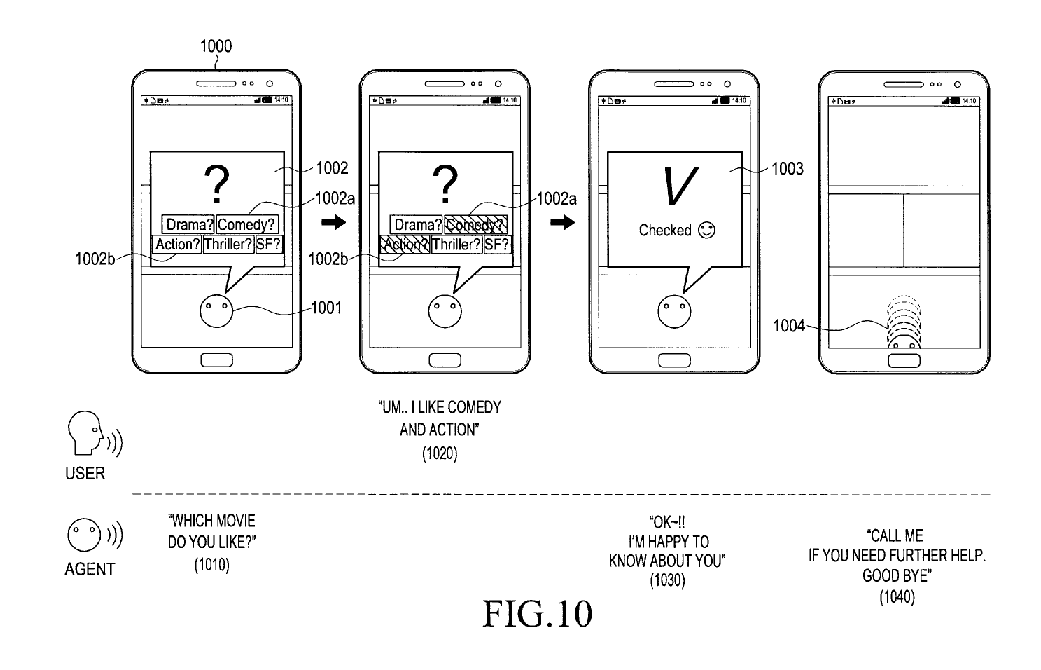

FIG. 10 illustrates an example of an operation for outputting a query for acquiring user information according to various embodiments of the present disclosure.

According to various embodiments of the present disclosure, when the user reserves a movie ticket through an electronic device 1000, the agent may acquire user information related to the movie. For example, the agent may determine that the user reserves the movie ticket and a task related to schedule generation is terminated based on a movie viewing schedule generated through a schedule management application or information related to the movie reservation received through a server of a film company.

According to various embodiments of the present disclosure, when the electronic device 1000 identifies the selection of the “ok” button and performs an operation for storing the generated schedule, the electronic device 1000 may determine that a task for schedule generation is termination in the corresponding application. For example, when a query for inquiring about whether to perform the operation for acquiring user information is output and a response to the output query is received, the agent may perform the operation for acquiring the user information.

In operation 1010, the agent may output the content of “Which movie do you like?” as the query for acquiring user information related to data of the movie reservation task. For example, when outputting the query, the agent may output a selection item 1002 for the output query along with an image 1001 of the agent through a display of the electronic device 1000. For example, the selection item 1002 may include at least one item (for example, “Drama?”, “Comedy?” 1002a, “Action?” 1002b, “Thriller?,” or “SF?” for Science Fiction) which can be selected by the user.

According to various embodiments of the present disclosure, the agent may identify user's behavior and tendency information among the user information and, when information on a movie genre is not identified in “movie information” of the behavior and tendency information, output a query that inquires about which movie is preferred as a query for generating the “movie information” in the behavior and tendency information of the user information.

In operation 1020, the user may select the “Comedy?” 1002a or the “Action?” 1002b in the selection item 1002 or may input voice data such as, “Um . . . I like comedy and action,” which indicates a preference for comedy or action.

In operation 1030, the agent may store information on the selected item and output a message informing of the termination of the operation for acquiring the user information. For example, the message may include the content of “Ok˜!! I'm happy to know about you”.

According to various embodiments of the present disclosure, the agent may insert data on the selected item into a data field corresponding to the movie genre and store the data in the “movie information” of the user.

When the performance of the operation for acquiring the user information is terminated, the agent may output various displays and voice data in operation 1040. For example, the agent may control display of the agent image 1004 such that the agent image 1001 of the agent disappears via an animation 1004, and/or output the content of “Call me if you need further help. Good bye,” as further content notifying a user of the termination.

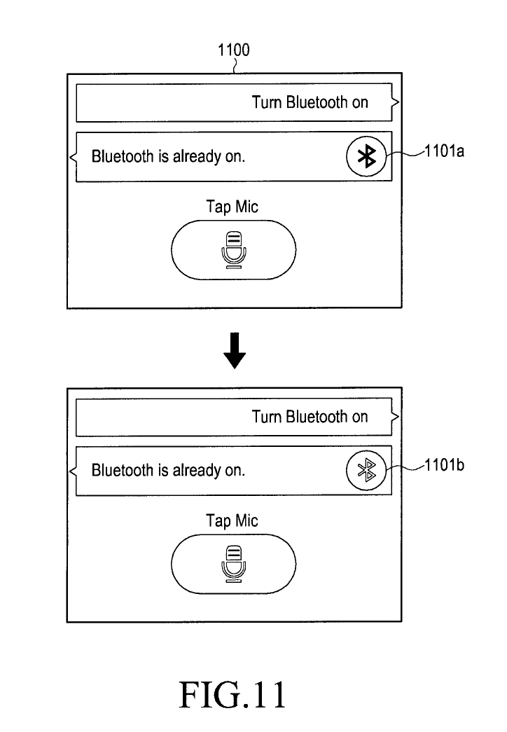

FIG. 11 illustrates an example of an operation in which the electronic device outputs a response according to various embodiments of the present disclosure.

According to various embodiments of the present disclosure, the electronic device may receive a command from the user based on a voice recognition and may be connected to the agent that provides a response to the command.

Referring to FIG. 11, a screen 1100 displayed when the electronic device communicates with the agent in order to display both a command received from the user, and the subsequent response of the agent corresponding to the command.

According to various embodiments of the present disclosure, the user may input data corresponding to “Turn Bluetooth on”, which may serve as a command to activate short-range communication (for example, Bluetooth communication).

The agent may cause display or output of a button 1101a for activating the requested short-range communication (for example, Bluetooth) in response to the command. For example, in order to indicate that the output button has been selected as to perform the requested function, the electronic device may cause the button to be displayed with various effects such as highlighting, altering a color, and flickering 1101b.

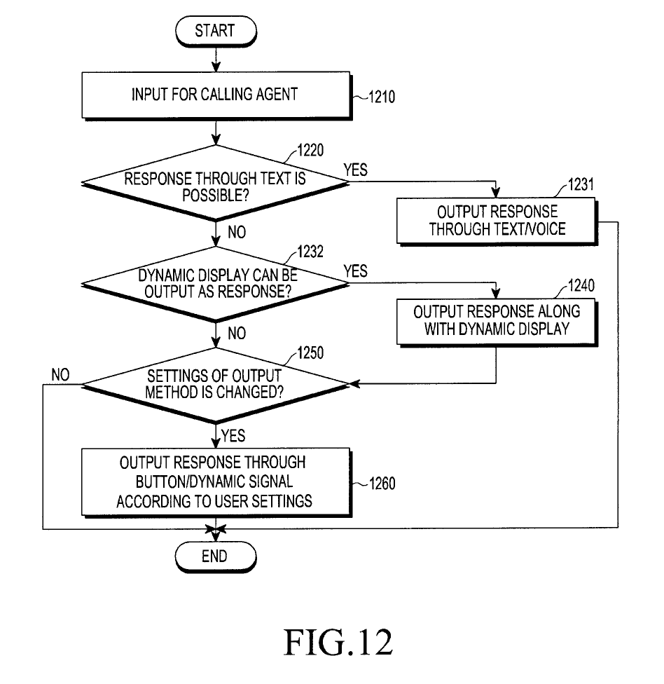

FIG. 12 is a flowchart illustrating an example of an operation in which the electronic device outputs a response according to various embodiments of the present disclosure.

Referring to FIG. 12, in operation 1210, the electronic device may detect an input for calling (e.g., requesting activation of) the agent. For example, the electronic device may call the agent when a task is terminated, when determining a need to acquire user information that is missing and correlating with the data of the terminated task, or in response to detecting an input, such as a preset user input.

According to various embodiments of the present disclosure, the agent may output a query for user information to be acquired, or an identification result of the command requested by the user.

In operation 1220, the electronic device may determine whether the electronic device can respond to the query or the identification result using text.

When it is determined that the electronic device can respond using text in operation 1220, the electronic device may output a response including text and voice data corresponding to the output text in operation 1231.

When it is determined that the electronic device cannot respond to the query or the identification result through text in operation 1220, the electronic device may determine whether the response can be output through a dynamic display in operation 1232. For example, it may be determined that the response cannot be output through text when data for the response or the identification result exceeds an amount of data which can be displayed on one screen.

When it is determined that the response can be output through the dynamic display in operation 1232, the electronic device may output the response using the dynamic display in operation 1240. For example, the dynamic display of the response may include an effect of emphasizing a button for selectable to execute the command requested by the user, or a displaying instructions/operations for executing the requested function using one or more corresponding buttons.

When it is determined that the response cannot be displayed through the dynamic display in operation 1232 or as operation 1240 is performed, the electronic device may determine whether a request for changing an output method is made in operation 1250. For example, a configuration controlling output of the corresponding response through text data, voice data, image data, or dynamic display may be determined by user settings, and a voice tone or a sound volume of the voice data may be configured.

When the request for changing the output method is made based on a result of the performance of operation 1250, the electronic device may identify the user settings for the response output and output the response through a dynamic button or various signals based on the user settings in operation 1260.

At least one of the operations illustrated in FIG. 12 may be omitted, or at least one other operation may be added between the operations. In addition, the operations may be sequentially processed as illustrated in FIG. 12, and the execution sequence of at least one operation may be switched with that of another operation.

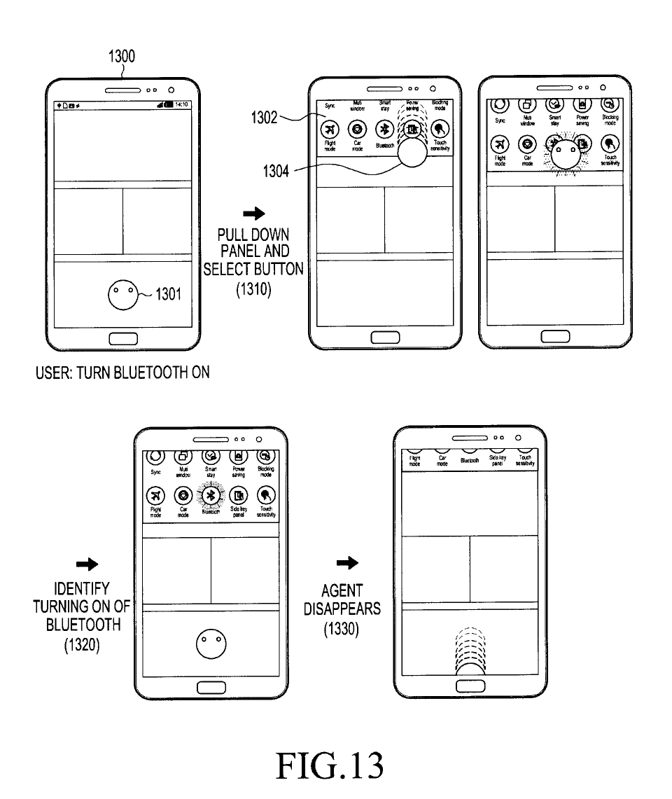

FIG. 13 illustrates an example of an operation in which the electronic device outputs a response according to various embodiments of the present disclosure.

According to various embodiments of the present disclosure, when a command (for example, a voice input such as “turn Bluetooth on”) for activating short-range communication (for example, Bluetooth) is input through a voice recognition-based agent, the electronic device 1300 may output a response corresponding to the command. For example, the electronic device 1300 may identify the input command, and display available operations relevant to performing a function corresponding to the command in a current task.

Referring to FIG. 13, in operation 1310, the electronic device may display an animation pulling down the panel 1302 and repositioning an agent image 1301, via an animation 1304, proximate to or overlaying a button selectable to execute a requested function. For example, the panel may include a screen having a button corresponding to at least one function.

In operation 1320, the electronic device may display an operation selecting a button on which the agent image 1301 is disposed and activate the corresponding function. For example, in response to detecting that the button for activating a Bluetooth function is selected, the electronic device may activate the Bluetooth function.

When a response to the command is output, the electronic device may determine that the requested task is completed, and update display of the panel 1302 and/or the agent image 1301 in operation 1330. For example, in the illustrated example, the panel 1302 is removed from display (e.g., animated as sliding upwards) and the agent image 1301 is also removed (e.g., animated as sliding downwards), and thus the user is notified that the command request by the user has been executed successfully.

At least one of the operations illustrated in FIG. 13 may be omitted, or at least one other operation may be added between the operations. In addition, the operations may be sequentially processed as illustrated in FIG. 13, and the execution sequence of at least one operation may be switched with that of another operation.

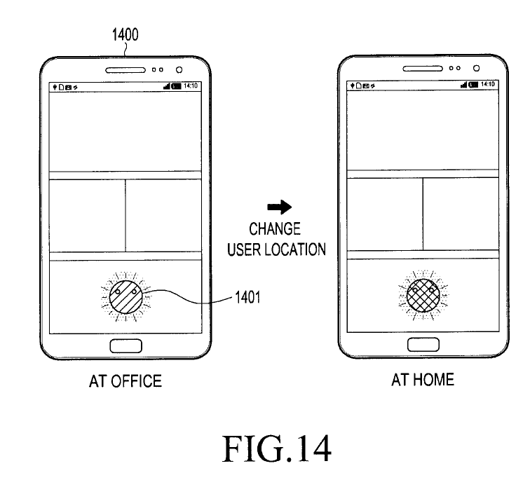

FIG. 14 illustrates an example of an operation in which the electronic device applies a visual effect to the display agent icon according to various embodiments of the present disclosure.

Referring to FIG. 14, an electronic device 1400 may identify user settings instructing application of a visual effect to an agent image 1401. For example, the user settings may include a function altering a color, size, and shape according to a location of the electronic device 1400.

According to various embodiments of the present disclosure, when it is determined that the user is in a first location (for example, office), the electronic device 1400 may apply an effect configured for the first location to the image 1401 of the agent and display the modified agent image 1401.

According to various embodiments of the present disclosure, when the user moves from the first location to a second location (for example, home), the electronic device 1400 may apply an effect configured for the second location to the image 1401 of the agent and output the modified agent image 1401.

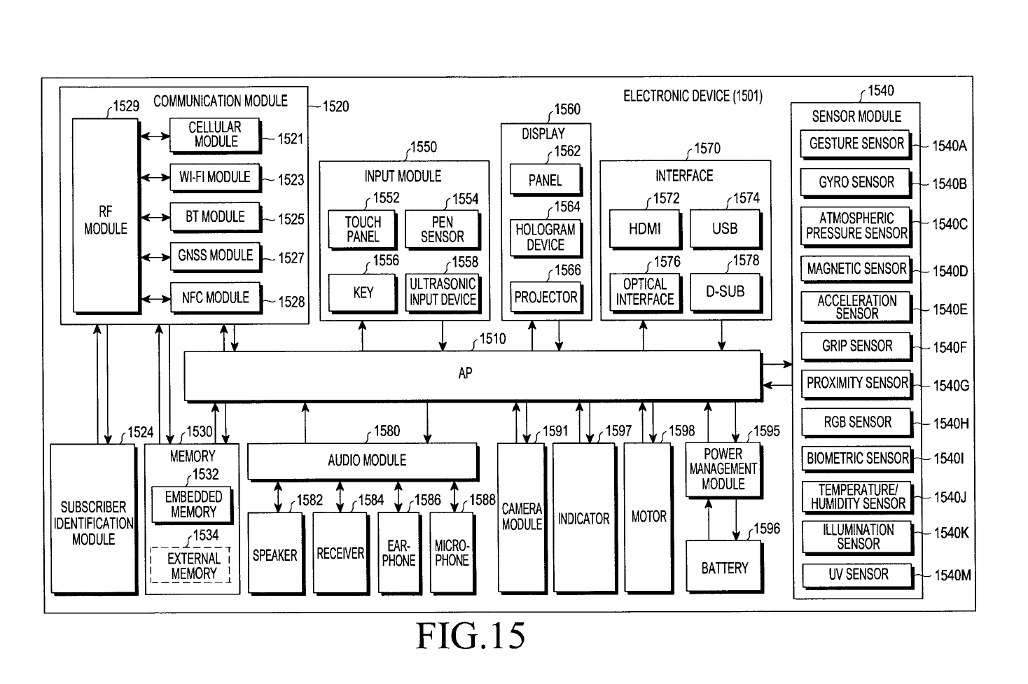

FIG. 15 is a block diagram illustrating an example of a configuration of an electronic device according to various embodiments of the present disclosure.

Referring to FIG. 15, an electronic device 1501 may include, for example, the entirety or a part of the electronic device 101 illustrated in FIG. 1. The electronic device 1501 may include at least one Application Processor (AP) 1510, a communication module 1520, a subscriber identification module 1524, a memory 1530, a sensor module 1540, an input device 1550, a display 1560, an interface 1570, an audio module 1580, a camera module 1591, a power management module 1595, a battery 1596, an indicator 1597, and a motor 1598.

The processor 1510 may control a plurality of hardware or software components connected to the processor 1510 by driving an operating system or an application program and perform processing of various pieces of data and calculations. The processor 1510 may be implemented by, for example, a System on Chip (SoC). According to an embodiment, the processor 1510 may further include a Graphic Processing Unit (GPU) and/or an image signal processor. The processor 1510 may include at least some (for example, a cellular module 1521) of the elements illustrated in FIG. 15. The processor 1510 may load, into a volatile memory, instructions or data received from at least one (for example, a non-volatile memory) of the other elements and may process the loaded instructions or data, and may store various data in a non-volatile memory.

The communication module 1520 may have a configuration equal or similar to that of the communication module 170 of FIG. 1. The communication module 1520 may include, for example, the cellular module 1521, a Wi-Fi module 1523, a Bluetooth (BT) module 1525, a GNSS module 1527 (for example, a GPS module, a Glonass module, a Beidou module, or a Galileo module), an NFC module 1528, and a Radio Frequency (RF) module 1529.

The cellular module 1521 may provide a voice call, an image call, a text message service, or an Internet service through, for example, a communication network. According to an embodiment of the present disclosure, the cellular module 1521 may identify or authenticate an electronic apparatus in the communication network by using the subscriber identification module (for example, a Subscriber Identity Module (SIM) card) 1524. According to an embodiment, the cellular module 1521 may perform at least some of the functions that the AP 1510 may provide. According to an embodiment, the cellular module 1521 may include a Communication Processor (CP).

The Wi-Fi module 1523, the Bluetooth module 1525, the GNSS module 1527, or the NFC module 1528 may include, for example, a processor that processes data transmitted and received through the corresponding module. In some embodiments, at least some (two or more) of the cellular module 1521, the Wi-Fi module 1523, the Bluetooth module 1525, the GNSS module 1527, and the NFC module 1528 may be included in a single Integrated Chip (IC) or IC package.

The RF module 1529 may transmit/receive, for example, a communication signal (for example, an RF signal). The RF module 1529 may include, for example, a transceiver, a Power Amp Module (PAM), a frequency filter, a Low Noise Amplifier (LNA), or an antenna. According to another embodiment, at least one of the cellular module 1521, the Wi-Fi module 1523, the Bluetooth module 1525, the GNSS module 1527, and the NFC module 1528 may transmit/receive an RF signal through a separate RF module.

The subscriber identification module 1524 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 1530 (for example, the memory 130) may include, for example, an internal memory 1532 or an external memory 1534. The internal memory 1532 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disk drive, a Solid State Drive (SSD), and the like).

The external memory 1534 may further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 1534 may be functionally and/or physically connected to the electronic device 1501 through various interfaces.

The sensor module 1540 may measure a physical quantity or detect an operation state of the electronic device 1501, and may convert the measured or detected information into an electrical signal. The sensor module 1540 may include, for example, at least one of a gesture sensor 1540A, a gyro sensor 1540B, an atmospheric pressure sensor 1540C, a magnetic sensor 1540D, an acceleration sensor 1540E, a grip sensor 1540F, a proximity sensor 1540G, a color sensor 1540H (for example, a red, green, blue (RGB) sensor), a biometric sensor 1540I, a temperature/humidity sensor 1540J, an illuminance sensor 1540K, and an ultraviolet (UV) sensor 1540M. Additionally or alternatively, the sensor module 1540 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 1540 may further include a control circuit for controlling one or more sensors included therein. In some embodiments, the electronic device 1501 may further include a processor, which is configured to control the sensor module 1540, as a part of the processor 1510 or separately from the processor 1510 in order to control the sensor module 1540 while the processor 1510 is in a sleep state.

The input device 1550 may include, for example, a touch panel 1552, a (digital) pen sensor 1554, a key 1556, and an ultrasonic input device (or unit 1558. The touch panel 1552 may use at least one of, for example, a capacitive type, a resistive type, an infrared type, and an ultrasonic type. Also, the touch panel 1552 may further include a control circuit. The touch panel 1552 may further include a tactile layer and provide a tactile reaction to the user.

The (digital) pen sensor 1554 may include, for example, a recognition sheet which is a part of the touch panel or is separated from the touch panel. The key 1556 may include, for example, a physical button, an optical key, or a keypad. The ultrasonic input device 1558 may detect ultrasonic waves generated by an input tool through a microphone (for example, a microphone 1588) and identify data corresponding to the detected ultrasonic waves.

The display 1560 (for example, the display 160) may include a panel 1562, a hologram device 1564 or a projector 1566. The panel 1562 may include a configuration identical or similar to that of the display 160 illustrated in FIG. 1. The panel 1562 may be implemented to be, for example, flexible, transparent, or wearable. The panel 1562 and the touch panel 1552 may be implemented as one module. The hologram 1564 may show a three dimensional image in the air by using an interference of light. The projector 1566 may display an image by projecting light onto a screen. The screen may be located, for example, inside or outside the electronic device 1501. According to an embodiment, the display 1560 may further include a control circuit for controlling the panel 1562, the hologram device 1564, or the projector 1566.

The interface 1570 may include, for example, a High-Definition Multimedia Interface (HDMI) 1572, a Universal Serial Bus (USB) 1574, an optical interface 1576, or a D-subminiature (D-sub) 1578. The interface 1570 may be included in, for example, the communication module (e.g., interface) 170 illustrated in FIG. 1. Additionally or alternatively, the interface 1570 may include, for example, a Mobile High-definition Link (MHL) interface, a Secure Digital (SD) card/Multi-Media Card (MMC) interface, or an Infrared Data Association (IrDA) standard interface.

The audio module 1580 may bilaterally convert, for example, a sound and an electrical signal. At least some elements of the audio module 1580 may be included in, for example, the input/output interface 150 illustrated in FIG. 1. The audio module 1580 may process sound information which is input or output through, for example, a speaker 1582, a receiver 1584, earphones 1586, the microphone 1588 or the like.

The camera module 1591 is, for example, a device which may photograph a still image and a video. According to an embodiment of the present disclosure, the camera module 1591 may include one or more image sensors (for example, a front sensor or a back sensor), a lens, an Image Signal Processor (ISP) or a flash (for example, LED or xenon lamp).

The power management module 1595 may manage, for example, power of the electronic device 1501. According to an embodiment, the power management module 1595 may include a Power Management Integrated Circuit (PMIC), a charger Integrated Circuit (IC), or a battery 1596 or fuel gauge. The PMIC may have a wired and/or wireless charging scheme. Examples of the wireless charging method may include, for example, a magnetic resonance method, a magnetic induction method, an electromagnetic wave method, and the like. Additional circuits (for example, a coil loop, a resonance circuit, a rectifier, etc.) for wireless charging may be further included. The battery gauge may measure, for example, a residual quantity of the battery 1596, and a voltage, a current, or a temperature during the charging. The battery 1596 may include, for example, a rechargeable battery or a solar battery.

The indicator 1597 may display a particular state (for example, a booting state, a message state, a charging state, or the like) of the electronic device 1501 or a part (for example, the processor 1510) of the electronic device 1501. The motor 1598 may convert an electrical signal into mechanical vibration, and may generate vibration, a haptic effect, or the like. Although not illustrated, the electronic device 1501 may include a processing unit (for example, a GPU) for supporting a mobile television (TV). The processing unit for supporting mobile TV may, for example, process media data according to a certain standard such as Digital Multimedia Broadcasting (DMB), Digital Video Broadcasting (DVB), or mediaFlo™.

Each of the above-described component elements of hardware according to the present disclosure may be configured with one or more components, and the names of the corresponding component elements may vary based on the type of electronic device.

In various embodiments of the present disclosure, the electronic device may include at least one of the above-described elements. Some of the above-described elements may be omitted from the electronic device, or the electronic device may further include additional elements. Further, some of the elements of the electronic device according to various embodiments of the present disclosure may be coupled to form a single entity while performing the same functions as those of the corresponding elements before the coupling.

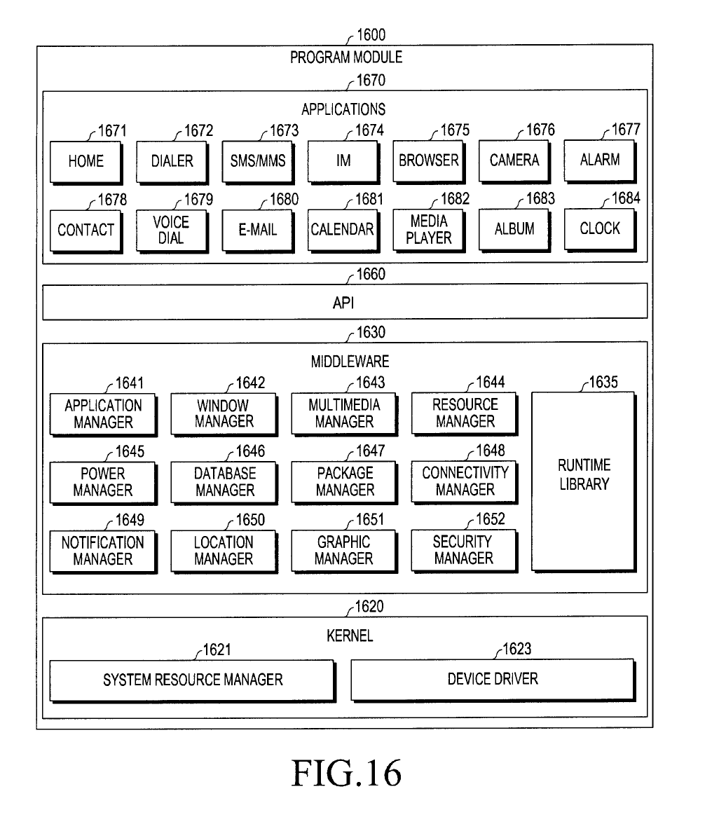

FIG. 16 is a block diagram illustrating an example of a configuration of a program module 1600 according to various embodiments of the present disclosure.

Referring to FIG. 16, the program module 1610 (for example, the program 140) may include an Operating System (OS) for controlling resources related to the electronic device (for example, the electronic device 101) and/or various applications (for example, the application programs 147) executed in the operating system.

The operating system may be, for example, Android, iOS, Windows, Symbian, Tizen, Bada, or the like.

The program module 1610 may include a kernel 1620, middleware 1630, an Application Programming Interface (API) 1660, and/or applications 1670. At least some of the program module 1610 may be preloaded on the electronic device, or may be downloaded from an external electronic device (for example, the electronic device 102 or 104, or the server 106).

The kernel 1620 (for example, the kernel 141) may include, for example, a system resource manager 1621 and/or a device driver 1623. The system resource manager 1621 may perform the control, allocation, retrieval, or the like of system resources. According to an embodiment, the system resource manager 1621 may include a process management unit, a memory management unit, or a file system management unit. The device driver 1623 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 1630 may provide a function utilized by the applications 1670 in common or provide various functions to the applications 1670 through the API 1660 so that the applications 1670 can efficiently use limited system resources within the electronic device. According to an embodiment, the middleware 1630 (for example, the middleware 143) may include, for example, at least one of a runtime library 1635, an application manager 1641, a window manager 1642, a multimedia manager 1643, a resource manager 1644, a power manager 1645, a database manager 1646, a package manager 1647, a connectivity manager 1648, a notification manager 1649, a location manager 1650, a graphic manager 1651, and a security manager 1652.

The runtime library 1635 may include a library module which a compiler uses in order to add a new function through a programming language while the applications 1670 are being executed. The runtime library 1635 may perform input/output management, memory management, the functionality for an arithmetic function, or the like.

The application manager 1641 may manage, for example, a life cycle of at least one of the applications 1670. The window manager 1642 may manage Graphical User Interface (GUI) resources used for the screen. The multimedia manager 1643 may determine a format utilized to reproduce various media files, and may encode or decode a media file by using a coder/decoder (codec) appropriate for the corresponding format. The resource manager 1644 may manage resources, such as a source code, a memory, a storage space, and the like of at least one of the applications 1670.

The power manager 1645 may operate together with, for example, a Basic Input/Output System (BIOS), etc. and may manage a battery or power, and may provide power information and the like utilized for an operation of the electronic apparatus. The database manager 183G may generate, search for, and/or change a database to be used by at least one of the applications 1670. The package manager 1647 may manage the installation or update of an application distributed in the form of a package file.

The connectivity manager 1648 may manage a wireless connection such as, for example, Wi-Fi or Bluetooth. The notification manager 1649 may display or notify of an event, such as an arrival message, an appointment, a proximity notification, and the like, in such a manner as not to disturb the user. The location manager 1650 may manage location information of the electronic device. The graphic manager 1651 may manage a graphic effect, which is to be provided to the user, or a user interface related to the graphic effect. The security manager 1652 may provide various security functions utilized for system security, user authentication, and the like. According to an embodiment, when the electronic device (for example, the electronic device 101) has a telephone call function, the middleware 1630 may further include a telephony manager that manages a voice or video call function of the electronic device.

The middleware 1630 may include a middleware module that forms a combination of various functions of the above-described elements. The middleware 1630 may provide a module specialized for each type of OS in order to provide a differentiated function. Also, the middleware 1630 may dynamically delete some of the existing elements, or may add new elements.

The API 1660 (for example, the API 145) may be, for example, a set of API programming functions and may have different configurations according to operating systems. For example, in the case of Android or iOS, one API set may be provided for each platform. In the case of Tizen, two or more API sets may be provided for each platform.

The applications 1670 (for example, the application programs 147) may include, for example, one or more applications which can provide functions such as home 1671, dialer 1672, SMS/MMS 1673, Instant Message (IM) 1674, browser 1675, camera 1676, alarm 1677, contacts 1678, voice dial 1679, email 1680, calendar 1681, media player 1682, album 1683, clock 1684, health care (for example, measure exercise quantity or blood sugar), or environment information (for example, atmospheric pressure, humidity, or temperature information).

According to an embodiment, the applications 1670 may include an application (hereinafter, referred to as an “information exchange application” for convenience of description) that supports information exchange between the electronic device (for example, the electronic device 101) and an external electronic device (for example, the electronic device 102 or 104). The information exchange application may include, for example, a notification relay application for transferring specific information to an external electronic device or a device management application for managing an external electronic device.

For example, the notification relay application may include a function of transferring, to the external electronic device (for example, the electronic device 102 or 104), notification information generated from other applications of the electronic device (for example, an SMS/MMS application, an e-mail application, a health management application, or an environmental information application). Further, the notification relay application can, for example, receive notification information from the external electronic device and provide the received notification information to a user.

The device management application may manage (for example, install, delete, or update), for example, at least one function of an external electronic device (for example, the electronic device 102 or 104) communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

According to an embodiment, the applications 1670 may include applications (for example, a health care application of a mobile medical appliance, and the like) designated according to the attributes of an external electronic device (for example, the electronic device 102 or 104). According to an embodiment, the applications 1670 may include applications received from an external electronic device (for example, the server 106 or the electronic device 102 or 104). According to an embodiment, the applications 1670 may include a preloaded application or a third party application that may be downloaded from a server. The names of the elements of the program module 1610, according to the embodiment illustrated in the drawing, may vary according to the type of operating system.

According to various embodiments of the present disclosure, at least some of the programming module 1610 may be embodied as software, firmware, hardware, or a combination of at least two of them. At least some of the program module 1610 may be implemented (e.g., executed) by, for example, the processor (e.g., the processor 1510). At least some of the program module 1610 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present disclosure, and vice versa.

The programming module according to the present disclosure may include one or more of the aforementioned components or may further include other additional components, or some of the aforementioned components may be omitted.

The operations performed by the modules, programming module, or other elements according to various embodiments of the present disclosure may be executed in a sequential, parallel, repetitive, or heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the present disclosure. Therefore, it should be construed that all modifications and changes or modified and changed forms based on the technical idea of the present disclosure fall within the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

The control unit may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. An electronic device comprising:
an input/output interface;
a memory that stores first user information; and
a processor operatively coupled to the memory and the input/output interface, the processor configured to:
when a first task of a first application executed by the electronic device is terminated, output via the input/output interface a query requesting second user information related to at least one of the first task and the first user information, and
receive the requested second user information via a user input received by the input/output interface responsive to the query, and store the received second user information in the memory.

2. The electronic device of claim 1, wherein the processor is configured to:
determine whether the received user input includes the requested second user information and store the received user input in the memory when the received user input includes the requested second user information.

3. The electronic device of claim 1, wherein the processor is configured to: classify the first user information or the received second user information into classifications including basic information, location and connection information, and behavior and tendency information, and to store the classified first user information or classified second user information in the memory.

4. The electronic device of claim 1, wherein the output query includes at least one item selectable to generate a response to the output query indicating at least a portion of the requested second user information.

5. The electronic device of claim 4, wherein when the at least one item is selected, information corresponding to the selected at least one item is stored in the memory as at least the portion of the requested second user information.

6. The electronic device of claim 1, wherein the processor is further configured to:
execute a third task for outputting a response to a command;
detect, via a voice recognition function of the input/output interface, termination of the executed third task;
in response to the termination of the executed third task, determine whether third user information corresponding to the terminated third task is stored; and
if the third user information is not stored in the memory, output a query via the input/output interface requesting the third user information corresponding to the terminated third task.

7. The electronic device of claim 1, wherein the processor is further configured to:
execute a fourth task;
terminate the fourth task in response to detecting at least one of selection of a preset button and execution of an operation related to at least one of completion of the fourth task and storage of the fourth task in the electronic device; and
in response to detecting termination of the fourth task, output by the input/output interface a query requesting fourth user information related to at least one keyword associated with the terminated fourth task.

8. The electronic device of claim 1, wherein the processor is further configured to:
execute a fifth task associated with downloading an application; and
when the fifth task is terminated in the electronic device, output via the input/output interface a query requesting fifth user information related to at least one application associated with the fifth task.

9. The electronic device of claim 1, wherein the processor is configured to:
output by the input/output interface a query request additional information included in the requested second user information based on the received user input and the received second user information.

10. A method of acquiring user information in an electronic device, the method comprising:
storing in a memory first user information;
detecting by a processor when a first task of a first application executed by the electronic device is terminated, and when the first task is terminate, outputting via an input/output interface a query requesting second user information associated with at least one of the first task and the stored first user information; and
receive the request second user information via a user input received by the input/output interface response to the query, and store the received second user information in in the memory.

11. The method of claim 10, further comprising:
determining whether the received user input includes the requested second user information; and
when the received user input includes the requested second user information, storing the received input in the memory as the second user information.

12. The method of claim 10, further comprising:
classifying the first user information or the received second user information into classifications including basic information, location and connection information, and behavior and tendency information, and storing the classified first user information or classified second user information in the memory.

13. The method of claim 10, wherein the output query includes at least one item selectable to generate a response to the output query indicating at least a portion of the requested second user information.

14. The method of claim 10, further comprising:
when the at least one item is selected, information corresponding to the selected at least one item is stored in the memory as at least the portion of the requested second user information.

15. The method of claim 10, further comprising:
executing by the processor a third task for outputting a response to a command;
detecting, via a voice recognition function of the input/output interface, termination of the executed third task;
in response to the termination of the executed third task, determining whether third user information related to the command is stored; and
if the third user information is not stored in the memory, outputting by the input/output interface a query requesting the third user information corresponding to the terminated third task.

16. The method of claim 10, further comprising:
executing a fourth task;
terminating the fourth task in response to detecting at least one of selection of a preset button and execution of an operation related to at least one of completion of the fourth task or storage of the fourth task in the electronic device; and
in response to detecting termination of the fourth task, outputting a query requesting fourth user information related to at least one keyword associated with the terminated fourth task.

17. The method of claim 10, further comprising:
executing a fifth task associated with downloading an application; and
when the fifth task is terminated in the electronic device, outputting via the input/output interface a query requesting fifth user information related to at least one application associated with the fifth task.

18. The method of claim 10, further comprising:
outputting by the input/output interface a query requesting additional information included in the requested second user information based on the received user input and the received second user information.
